(19) United States
(12) Patent Application Publication
(10) Pub. No.: US 2021/0149075 A1
(43) Pub. Date: May 20, 2021

(54) SYSTEM AND METHOD FOR LITHOFACIES CLASSIFICATION

(71) Applicant: Chevron U.S.A. Inc., San Ramon, CA (US)

(72) Inventors: Justin Curtis Palmer, Houston, TX (US); Stuart Blackwood, Houston, TX (US)

(21) Appl. No.: 16/950,806

(22) Filed: Nov. 17, 2020

Related U.S. Application Data
(60) Provisional application No. 62/937,605, filed on Nov. 19, 2019.

(51) Int. Cl. G01V 11/00

(52) U.S. Cl. CPC G01V 11/00

(57) ABSTRACT

A method is described for lithofacies classification including receiving well logs representative of a subsurface volume of interest; deriving lithofacies from the well logs based on lithofacies cutoffs; calculating thickness of individual beds of the lithofacies; defining thickness thresholds based on the thickness of individual beds; upscaling to filter thin beds from thick beds based on the thickness thresholds; and classifying lithofacies intervals based on the upscaling. The method may be executed by a computer system.

### CROSS-REFERENCE TO RELATED APPLICATIONS

This application claims priority benefit from U.S. Provisional Patent Application 62/937,605 filed Nov. 19, 2019.

### STATEMENT REGARDING FEDERALLY SPONSORED RESEARCH OR DEVELOPMENT

Not applicable.

### TECHNICAL FIELD

The disclosed embodiments relate generally to techniques for classifying rock facies (also called lithofacies) based on wireline log data from subsurface reservoirs for the purpose of hydrocarbon exploration and production.

### BACKGROUND

Petrophysical calculations identify net sand in potential hydrocarbon-bearing rock formations based on thresholds from one or more wireline logs. Calculations are completed at every depth within the log data, which is typically sampled every ½ foot. Net sand refers to the thickness of sand within a specified gross interval. The gross interval usually relates to stratigraphic age (e.g. 11.8-12.2 Ma) and is defined by a stratigrapher. Net-to-gross calculations (NTG) are then completed that permit analysis of sand quantity between wells and across regions. However, not all net sand is created equal. Sand may be distributed in multiple thin sand lenses across an interval or in a single thick sand body. The implications of this quality distribution can impact exploration programs. We needed a method to classify sands that takes into account this variability. In the past, manual classification of sand packages, or flow units, has been done from several wells in an area. However, this method is inefficient, subjective, and subject to human error. We needed a method that was objective, repeatable, and scalable to thousands of well across a basin.

There exists a need for a method for classifying rock facies from wireline log data using thickness and wireline log value thresholds that is iterative and simple.

### SUMMARY

In accordance with some embodiments, a method of lithofacies classification including receiving well logs representative of a subsurface volume of interest; deriving lithofacies from the well logs based on lithofacies cutoffs; calculating thickness of individual beds of the lithofacies; defining thickness thresholds based on the thickness of individual beds; upscaling to filter thin beds from thick beds based on the thickness thresholds; and classifying lithofacies intervals based on the upscaling is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates the technical problem and solution of the present invention, in accordance with some embodiments:

FIG. 2 illustrates a flowchart of the present invention, in accordance with some embodiments;

FIG. 3 illustrates steps of the present invention, in accordance with some embodiments;

FIG. 4 illustrates steps of the present invention, in accordance with some embodiments;

FIG. 5 illustrates steps of the present invention, in accordance with some embodiments;

FIG. 6 illustrates a flowchart of the present invention, in accordance with some embodiments; and

FIG. 7 is a block diagram illustrating a rock classification system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of classifying lithofacies based on wireline logs.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

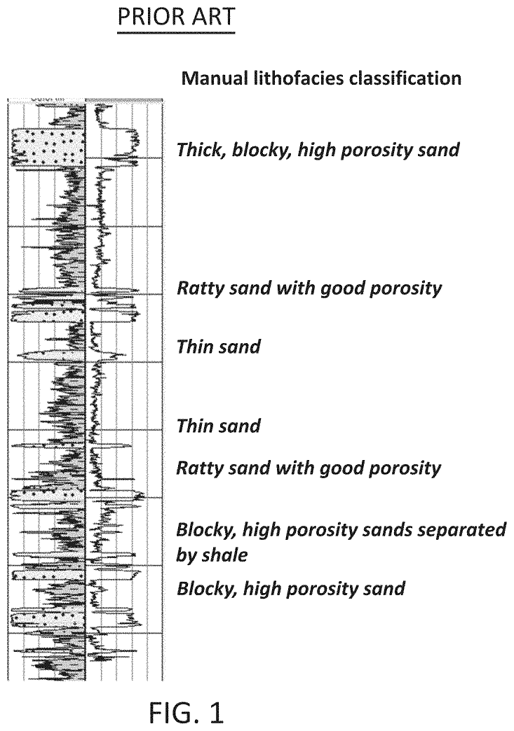

FIG. 1 defines the technical problem that arises during hydrocarbon exploration when wireline logs are used to classify rock facies. The prior art method of manual lithofacies classification is subjective and not always repeatable. We needed a way to differentiate sand types and classify them based on their thicknesses, the presence or lack of intraformational shale, and their proximity to other sands. We needed to be able to differentiate high NTG sand (thick, blocky sands) from low NTG sand (ratty sands with intraformational shale) from thin sands.

The present invention objectively, reproducibly, and quickly classifies lithofacies using thickness, petrophysical logs (Vshale, PHIE, RHOB, PNP, DTC, etc.), and geologically meaningful thickness and petrophysical thresholds. The method may loop through multiple well logs from multiple wells across a basin to classify lithofacies. Lithofacies may be many rock types, such as carbonates, sand (sandstone), shale, thin-bedded sand, thin-bedded shale, thick-bedded sand, etc.

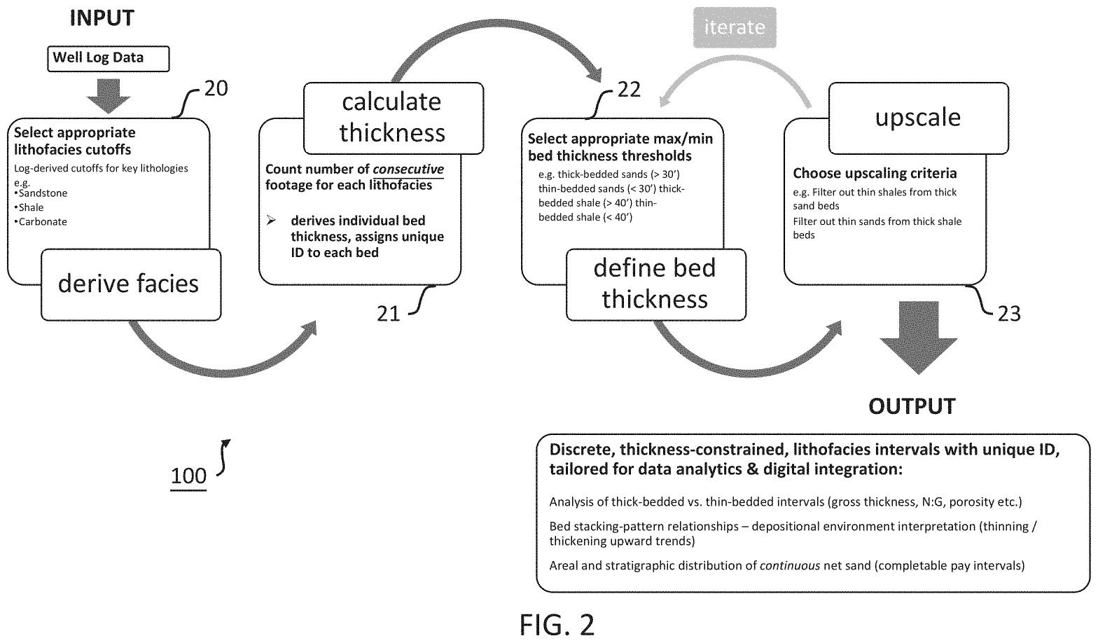

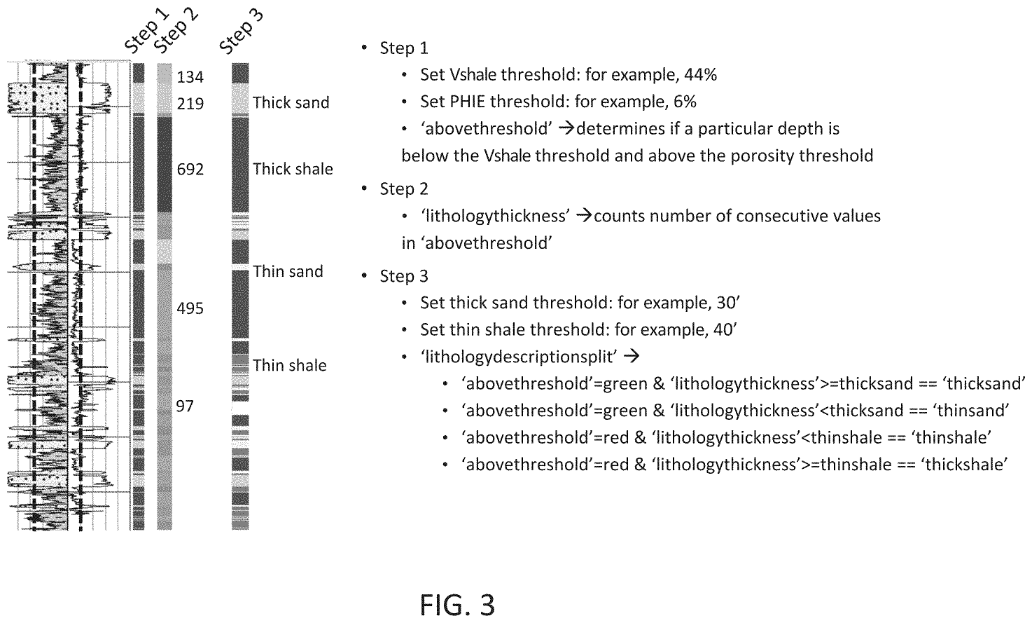

FIG. 2 illustrates a high-level flowchart of a method 100 for sand classification. After receiving the well log data, rock facies are derived 20 based on user-specified petrophysical parameters, as demonstrated, by way of example and not limitation, in FIG. 3 step 1. The threshold examples in FIG. 3 are not meant to be limiting; they will depend on the subsurface volume of interest. These lithofacies may include, for example, sandstone, shale, and carbonate.

Referring again to FIG. 2, method 100 then continues on to calculate the thicknesses 21 of individual beds of the lithofacies. This is based on the consecutive footage of each of the lithofacies. FIG. 3 step 2 demonstrates this.

Operation 22 of method 100 defines bed thicknesses 22 by setting minimum and maximum thicknesses to differentiate between, for example, thick-bedded sands, thin-bedded sands, thick-bedded shales, and thin-bedded shales. This is shown in FIG. 3 step 3.

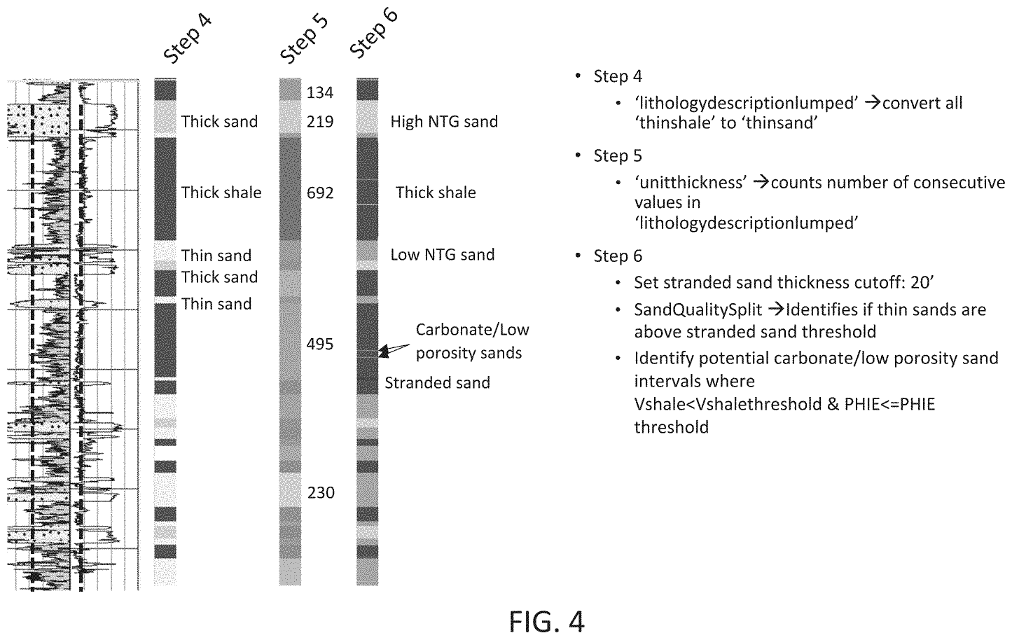

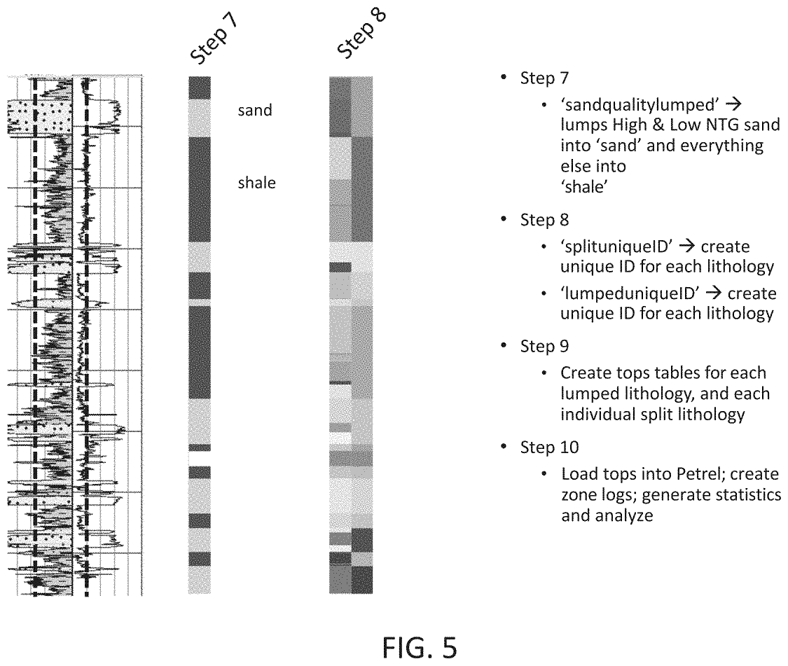

Operation 23 of method 100 performs upscaling. The upscaling criteria is designed to filter out thin-bedded lithofacies from thick-bedded lithofacies. This is demonstrated in FIG. 4 and FIG. 5, steps 4. Progressive iteration on operations 22 and 23 are meant to further upscale previously defined lithofacies based on new, user-specified criteria. This is demonstrated in FIG. 4 and FIG. 5, steps 5-7. A unique identification number is then generated for each lithofacies as defined by the algorithm, as demonstrated in FIG. 5, step 8. FIG. 5 steps 9 and 10, which are described but not shown, are used to generate the output as described in FIG. 2. Again, the threshold examples in FIG. 3 are not meant to be limiting; they will depend on the subsurface volume of interest. The output are discrete, thickness-constrained, lithofacies intervals with unique ID, tailored for data analytics and digital integration to enable analysis of thick-bedded vs. thin-bedded intervals (gross thickness, N:G, porosity, etc.), bed stacking-pattern relationships—depositional environment interpretation (thinning/thickening upward trends), and areal and stratigraphic distribution of continuous net sand (completable pay intervals). Examples of lithofacies analysis has thus far included 1) Analysis of areal and stratigraphic distributions of thin-bedded vs thick-bedded intervals for more effective interpretation of depositional facies and architectures; 2) Statistical analysis of variations in local gross interval thickness with presence and organization of thin-bedded vs thick-bedded sand facies; and 3) Analysis of compaction (porosity degradation with depth) and net-to-gross trends over predominantly thick-bedded, thin-bedded or mixed intervals.

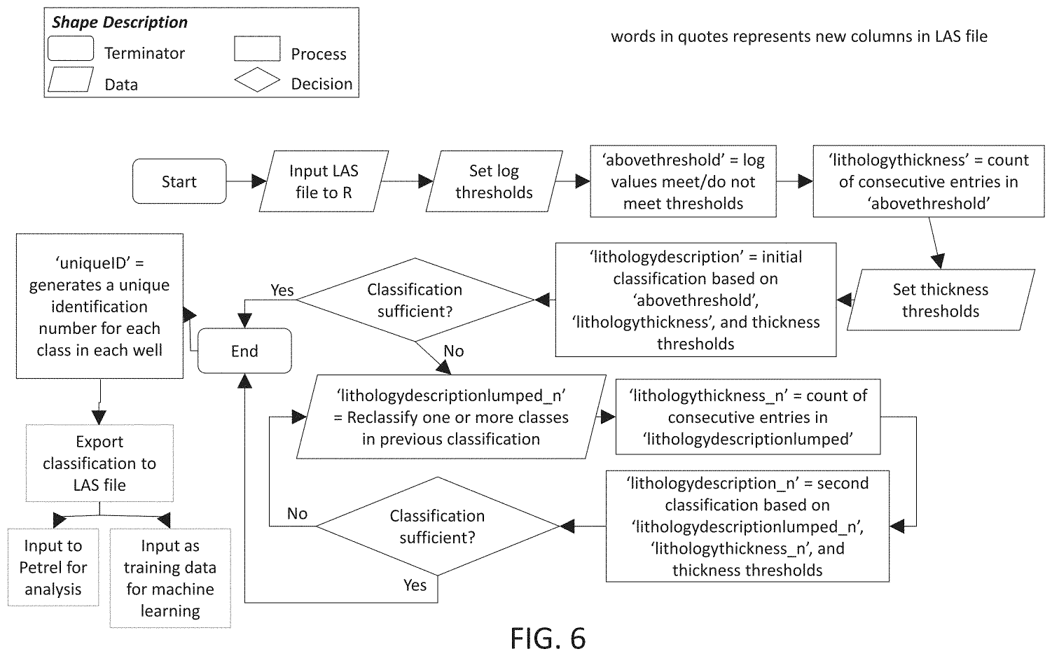

FIG. 6 is a flowchart of an example of the method of rock classification 100 as performed by a computer system. This flowchart provides a specific embodiment using LAS file inputs which have additional columns added by the steps of method 100. It also provides more detail about the iteration between defining bed thicknesses and upscaling for the purpose of refining the classification.

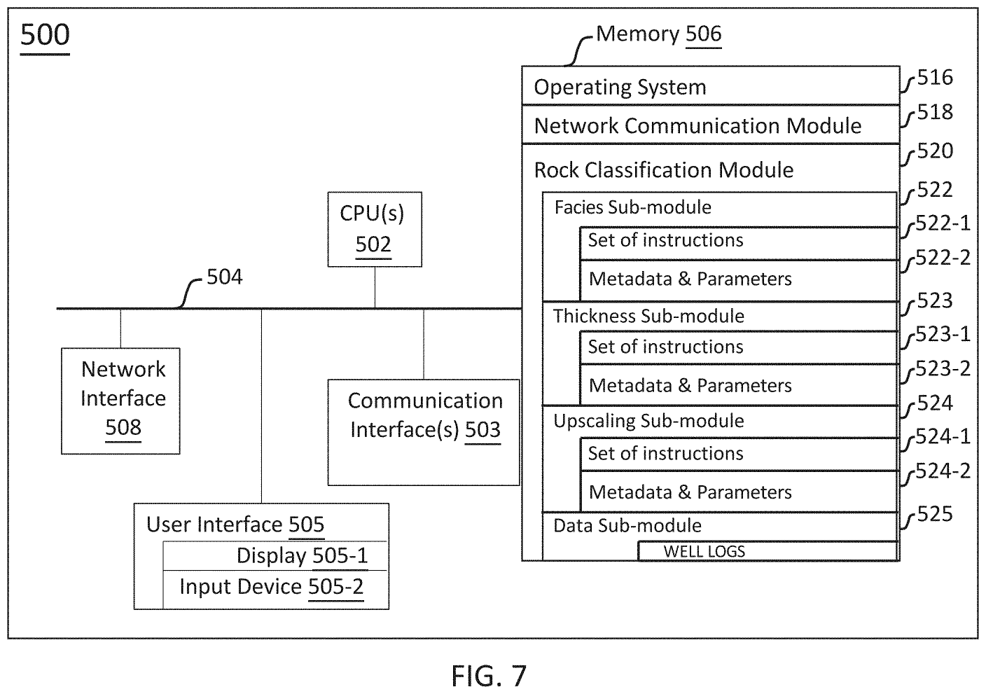

FIG. 7 is a block diagram illustrating a rock classification system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the rock classification system 500 includes one or more processing units (CPUs) 502, one or more network interfaces 508 and/or other communications interfaces 503, memory 506, and one or more communication buses 504 for interconnecting these and various other components. The rock classification system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store well logs and/or geologic information.

In some embodiments, memory 506 or the non-transitory computer readable storage medium of memory 506 stores the following programs, modules and data structures, or a subset thereof including an operating system 516, a network communication module 518, and a rock classification module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the rock classification module 520 executes the operations of the methods described herein. Rock classification module 520 may include data sub-module 525, which handles the wireline data including well logs. This data is supplied by data sub-module 525 to other sub-modules.

Facies sub-module 522 contains a set of instructions 522-1 and accepts metadata and parameters 522-2 that will enable it to execute operation 20 of method 100. The thickness sub-module 523 contains a set of instructions 523-1 and accepts metadata and parameters 523-2 that will enable it to contribute to operations 21 and 22 of method 100. The upscaling sub-module 524 contains a set of instructions 524-1 and accepts metadata and parameters 524-2 that will enable it to execute at least operation 23 of method 100. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generate the image. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 7) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of rock classification, comprising:
a. receiving, at a computer processor, well logs representative of a subsurface volume of interest;
b. deriving lithofacies from the well logs based on lithofacies cutoffs;
c. calculating thickness of individual beds of the lithofacies;
d. defining thickness thresholds based on the thickness of individual beds;
e. upscaling to filter thin beds from thick beds based on the thickness thresholds; and
f. classifying lithofacies intervals based on the upscaling.

2. The method of claim 1 further comprising repeating the defining and upscaling to refine the lithofacies intervals.

3. The method of claim 1 further comprising performing the method on well logs from multiple wells throughout a basin of interest.

4. The method of claim 1 wherein the lithofacies include at least one of sand, shale, and carbonate.

5. The method of claim 1 further comprising using the lithofacies intervals to analyze thick-bedded vs. thin-bedded intervals.

6. The method of claim 1 further comprising using the lithofacies intervals to analyze depositional environments.

7. The method of claim 1 further comprising using the lithofacies intervals to generate maps of areal and stratigraphic distributions of continuous lithofacies.

8. A computer system, comprising:
one or more processors;
memory; and
one or more programs, wherein the one or more programs are stored in the memory and configured to be executed by the one or more processors, the one or more programs including instructions that when executed by the one or more processors cause the system to execute:
a. receiving, at the one or more processors, well logs representative of a subsurface volume of interest;
b. deriving lithofacies from the well logs based on lithofacies cutoffs;
c. calculating thickness of individual beds of the lithofacies;
d. defining thickness thresholds based on the thickness of individual beds;
e. upscaling to filter thin beds from thick beds based on the thickness thresholds; and
f. classifying lithofacies intervals based on the upscaling.

9. A non-transitory computer readable storage medium storing one or more programs, the one or more programs comprising instructions, which when executed by an electronic device with one or more processors and memory, cause the device to execute:
a. receiving, at the one or more processors, well logs representative of a subsurface volume of interest;
b. deriving lithofacies from the well logs based on lithofacies cutoffs;
c. calculating thickness of individual beds of the lithofacies;
d. defining thickness thresholds based on the thickness of individual beds;
e. upscaling to filter thin beds from thick beds based on the thickness thresholds; and
f. classifying lithofacies intervals based on the upscaling.
